(19) United States
(12) Patent Application Publication
(10) Pub. No.: US 2020/0351888 A1
(43) Pub. Date: Nov. 5, 2020

(54) QUASI-CO LOCATION (QCL) FOR CROSS CARRIER SCHEDULING TECHNIQUES

(71) Applicant: QUALCOMM Incorporated, San Diego, CA (US)

(72) Inventors: Huilin XU, San Diego, CA (US); Yan ZHOU, San Diego, CA (US); Peter Pui Lok ANG, San Diego, CA (US); Tao LUO, San Diego, CA (US)

(21) Appl. No.: 16/804,862

(22) Filed: Feb. 28, 2020

Related U.S. Application Data
(60) Provisional application No. 62/843,202, filed on May 3, 2019.

(51) Int. Cl. H04W 72/04; H04W 72/12; H04W 76/11; H04W 76/27; H04L 5/00; H04W 80/02

(52) U.S. Cl. CPC H04W 72/0493; H04W 72/1257; H04W 76/11; H04W 80/02; H04W 72/042; H04L 5/0092; H04W 76/27

(57) ABSTRACT

Certain aspects of the present disclosure provide techniques for wireless communication. The method generally includes receiving, from a network entity, signaling indicating a transmission configuration indictor (TCI) state, determining a default quasi-co location (QCL) parameter based on the TCI state for communication via a first cell of a cross-carrier scheduling protocol, and communicating with the network entity based on the default QCL parameter.

### CROSS-REFERENCE TO RELATED APPLICATIONS

This application claims priority to and benefit of U.S. Provisional Patent Application Ser. No. 62/843,202, filed on May 3, 2019, which is expressly incorporated herein by reference in its entirety as if fully set forth below and for all applicable purposes.

### BACKGROUND

### Field of the Disclosure

Aspects of the present disclosure relate to wireless communications, and more particularly, to techniques for cross-carrier scheduling. Cross-carrier scheduling techniques can generally bring about high data rates and improved user experience.

### Description of Related Art

Wireless communication systems are widely deployed to provide various telecommunication services such as telephony, video, data, messaging, broadcasts, etc. Wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, next generation NodeB (gNB or gNodeB), TRP, etc.). A BS or DU may communicate with a set of UEs on downlink channels (e.g., for transmissions from a BS or DU to a UE) and uplink channels (e.g., for transmissions from a UE to a BS or DU).

Multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). NR supports beamforming, multiple-input multiple-output (MIMO) antenna technology, and carrier aggregation.

As the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communication. The method generally includes receiving, from a network entity, signaling indicating a transmission configuration indictor (TCI) state, the signaling comprising at least one of radio-resource control (RRC) signaling, medium access control (MAC) control element (CE), or downlink control information (DCI), determining a default quasi-co location (QCL) parameter based on the TCI state for communication via a scheduled cell of a cross-carrier scheduling protocol, the cross-carrier scheduling protocol being associated with a scheduling cell used to schedule resources in the scheduled cell, and communicating with the network entity based on the default QCL parameter.

Certain aspects provide a method for wireless communication. The method generally includes transmitting, to a user-equipment (UE), signaling indicating a TCI state, the signaling comprising at least one of RRC signaling, MAC CE, or DCI, wherein the TCI state is for communication via a scheduled cell of a cross-carrier scheduling protocol, the cross-carrier scheduling protocol being associated with a scheduling cell used to schedule resources in the scheduled cell, and communicating with the UE based on a default QCL parameter determined based on the TCI state.

Certain aspects provide an apparatus for wireless communication. The apparatus generally includes a memory, and a processing system coupled to the memory, wherein the processing system and the memory are configured to receive, from a network entity, signaling indicating a TCI state, the signaling comprising at least one of RRC signaling, MAC CE, or DCI, determine a default QCL parameter based on the TCI state for communication via a scheduled cell of a cross-carrier scheduling protocol, the cross-carrier scheduling protocol being associated with a scheduling cell used to schedule resources in the scheduled cell, and communicate with the network entity based on the default QCL parameter.

Certain aspects provide an apparatus for wireless communication. The apparatus generally includes a memory, and a processing system coupled to the memory, wherein the processing system and the memory are configured to transmit, to a UE, signaling indicating a TCI state, the signaling comprising at least one of RRC signaling, MAC CE, or DCI, wherein the TCI state is for communication via a scheduled cell of a cross-carrier scheduling protocol, the cross-carrier scheduling protocol being associated with a scheduling cell used to schedule resources in the scheduled cell, and communicate with the UE based on a default QCL parameter determined based on the TCI state.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example architecture of a distributed radio access network (RAN), in accordance with certain aspects of the present disclosure.

FIG. 3 illustrates a cross-scheduling protocol according to some aspects of the present disclosure.

FIG. 4 is a flow diagram illustrating example operations for wireless communication, in accordance with certain aspects of the present disclosure.

FIG. 5 is a flow diagram illustrating example operations for wireless communication, in accordance with certain aspects of the present disclosure.

FIG. 6 illustrates a communications device that may include various components configured to perform operations for techniques disclosed herein in accordance with aspects of the present disclosure.

FIG. 7 illustrates a communications device that may include various components configured to perform operations for techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for cross-carrier scheduling. Generally, in cross carrier scheduling use cases, scheduling information for one cell may be transmitted in another cell. Given that out-of-cell scheduling information may be transmitted on a different carrier via another cell, it is sometimes termed cross carrier. Cross-carrier scheduling enables leveraging another cell coverage area (sometimes termed a secondary cell) for transmitting scheduling information applying to a cell of interest (sometimes termed a primary cell). Utilizing cross-scheduling techniques brings about challenges unique to using multiple cells for control and data signaling.

Certain aspects of the present disclosure provide techniques for determining a quasi-co location (QCL) parameter for communication with a base station. For example, in some scenarios, a QCL parameter may not be available for a UE to use for decoding downlink signaling. In some aspects, a UE may determine a default QCL parameter, which may be used when another QCL parameter is unavailable, as described in more detail herein. For example, the UE may receive an indication of a set of active transmission configuration indictor (TCI) states, each associated with an identifier (ID). The UE may determine the default QCL parameter based on one of the set of activated TCI states having the lowest ID among the set of TCI states.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. In addition, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably.

A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2).

New Radio (NR) is an emerging wireless communications technology under development in conjunction with the 5G Technology Forum (5GTF). NR access (e.g., 5G NR) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

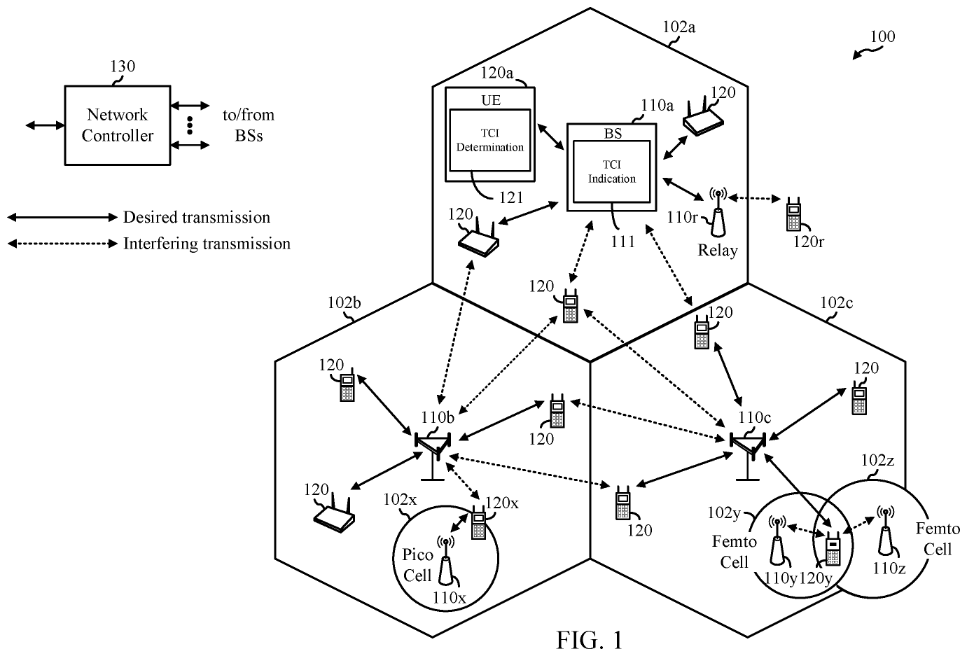

FIG. 1 illustrates an example wireless communication network 100 in which aspects of the present disclosure may be performed. For example, the wireless communication network 100 may be an NR system (e.g., a 5G NR network). For example, as shown in FIG. 1, the UE 120a has a transmission configuration indicator (TCI) determination module 121. The TCI determination module 121 may be configured to determine or provide a TCI. The TCI may be associated with a default quasi-co location (QCL) parameter, according to aspects described herein. For example, the TCI determination module 121 may receive signaling from a BS indicating a TCI state, and determine a default QCL parameter based on the TCI state. As an example, the signaling may indicate a set of active TCI states, each being associated with an identifier (ID). The UE may determine the default QCL based on the TCI state having the lowest ID among the set of active TCI states.

Also as shown in FIG. 1, the BS 110a has a TCI indication module 111. The TCI indication module 111 may be configured to transmit signaling indicating a TCI state to the UE. In certain aspects, the TCI state indicated to the UE may be used to determine a default QCL to be used for communication between the UE and the BS. For example, the signaling may indicate a set of active TCI-states, each being associated with an ID. The default QCL may be determined based on the TCI state having the lowest ID among the set of active TCI states.

As illustrated in FIG. 1, the wireless communication network 100 may include a number of base stations (BSs) 110 and other network entities. A BS may be a station that communicates with user equipments (UEs). Each BS 110 may provide communication coverage for a particular geographic area. In 3GPP, the term “cell” can refer to a BS's coverage area. In some aspects, BSs may be termed as a Node B (NB) and/or a NB subsystem serving a coverage area, depending on the context in which the term is used. In some NR systems, the term “cell” and BS, next generation NodeB (gNB or gNodeB), access point (AP), distributed unit (DU), carrier, or transmission reception point (TRP) may be used interchangeably. In some examples, a cell may not necessarily be stationary, and the geographic area of the cell may move according to the location of a mobile BS. In some examples, the BSs may be interconnected to one another and/or to one or more other BSs or network nodes (not shown) in wireless communication network 100. BSs can be connected via various types of backhaul interfaces, such as a direct physical connection, a wireless connection, a virtual network, or the like using any suitable transport network.

Any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), augmented reality device, a vehicle, a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing.

NR may utilize OFDM with a CP on the uplink and downlink and include support for half-duplex operation using TDD. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

In FIG. 1, a solid line with double arrows indicates desired transmissions between a UE and a serving BS. A BS may be designated to serve a UE on downlink and/or uplink communications. A finely dashed line with double arrows indicates potentially interfering transmissions between a UE and a BS. As cells may have varying coverage scopes, cells may overlap and/or have distinct coverage areas. As mentioned above, cross-carrier scheduling can involve sending information (data or control) for use in one cell via a different cell.

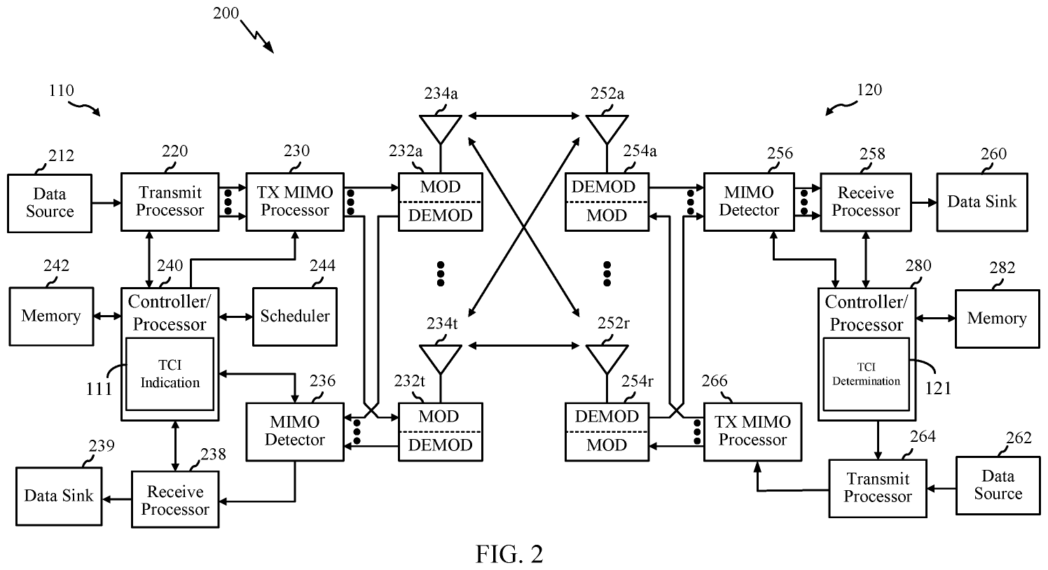

FIG. 2 illustrates example components of BS 110 and UE 120 (e.g., in the wireless communication network 100 of FIG. 1). These components may be used to implement aspects and operations described in the present disclosure. For example, antennas 252, processors 266, 258, 264, and/or controller/processor 280 of the UE 120 and/or antennas 234, processors 220, 230, 238, and/or controller/processor 240 of the BS 110 may be used to perform the various techniques and methods described herein.

As shown in FIG. 2, the controller/processor 240 of the BS 110 has a TCI indication module 111. The TCI indication module 111 may be configured to transmit signaling indicating a TCI state to the UE. In certain aspects, the TCI state indicated to the UE may be used to determine a default QCL to be used. For example, the signaling may indicate a set of active TCI-states, each being associated with an ID. The default QCL may be determined based on the TCI state having the lowest ID among the set of active TCI states.

As shown in FIG. 2, the controller/processor 280 of the UE 120 may include a TCI determination module 121. The TCI determination module 121 may be configured determine or provide a TCI state. The TCI may be associated with a default QCL. For example, the TCI determination module 121 may receive signaling from a BS indicating a TCI state, and determine a default QCL parameter based on the TCI state. As an example, the signaling may indicate a set of active TCI states, each being associated with an ID. The UE may determine the default QCL based on the TCI state having the lowest ID among the set of active TCI states.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the base station 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The controllers/processors 240 and 280 may direct the operation at the BS 110 and the UE 120, respectively. The controller/processor 240 and/or other processors and modules at the BS 110 may perform or direct the execution of processes for the techniques described herein. The memories 242 and 282 may store data and program codes for BS 110 and UE 120, respectively. A scheduler 244 may schedule UEs for data transmission on the downlink and/or uplink.

### Example Default Quasi-Co Location (QCL) for Cross-Carrier Scheduling

In cross-carrier scheduling operations, scheduling information intended for one cell may be transmitted in another cell. As one example, control signaling information may be exchanged between a UE and a BS in a first cell, though the UE and the BS may use the control information for scheduling communications in another cell. In other words, control signaling for a scheduled cell may be transmitted in a scheduling cell. According to some aspects, a user-equipment (UE) may decode control information (e.g., physical downlink control channel (PDCCH)) in the scheduling cell to obtain the scheduling information for both the scheduling cell and the scheduled cell. For example, the control information may provide a grant to the UE to decode a data or control channel on a scheduled cell. In other scenarios, cross-carrier communications may occur for other types of control signaling or data transmissions.

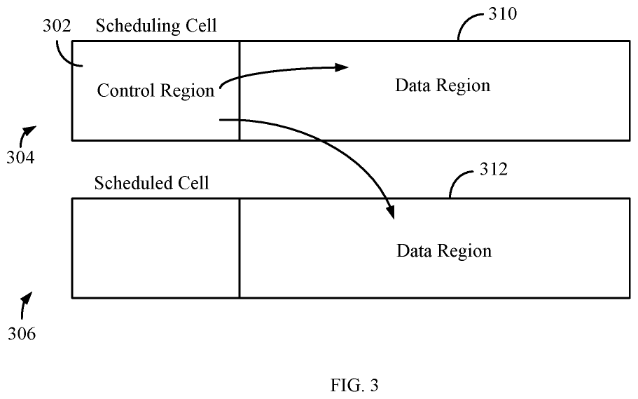

FIG. 3 illustrates a cross-scheduling protocol according to some aspects. For example, signaling in the control region 302 (e.g., physical downlink control channel (PDCCH)) of the scheduling cell 304 may be used to schedule resources for data (e.g., physical downlink shared channel (PDSCH)) for a different cell referred to as the scheduled cell 306. A control channel configuration in the scheduling cell's radio-resource control (RRC) signaling may be used by the UE to monitor for the control channel in the scheduling cell. Moreover, the control channel configuration in the scheduled cell's RRC signaling may be used by the UE to monitor for the control channel for the scheduled cell also in the scheduling cell.

DCI in the control region 302 of the scheduling cell 304 may be used to schedule data in the data region 310 of the scheduling cell 302. With cross-carrier scheduling, the DCI in the control region 302 of the scheduling cell 304 may also schedule resources in the data region 312 of the scheduled cell 312, as described herein.

Different transmission-configuration-indicator (TCI) states may be configured for communication in some aspects. This may apply to a variety of control and/or data signaling. For example, different TCI states may be used for communicating a PDSCH channel. A TCI state that is configured or determined for a reference signal or channel can provides a quasi-co location (QCL) source and/or QCL type associated with a signal or channel. For instance, in some aspects, a TCI state may indicate that a PDSCH demodulation reference signal (DMRS) is co-located with another reference signal. Thus, the UE may be able to use the other reference signal to assist the channel estimation of the PDSCH DMRS.

There are various types of QCL that may be used during communications. Some types are discussed in more detail in, for example, 3rd Generation Partnership Project (3GPP) Technical Specification (TS) 38.214. One type is termed ‘QCL-Type D’ and this type may indicate a beam's spatial property (e.g., direction and beam width).

A TCI state and QCL-Type D may be freely configured by a BS for PDSCH reception in any slot. There may be scenarios where a configured TCI state cannot be used or there is no TCI state configured. For example, a TCI state may not be used if a TCI state field is not included in the scheduling downlink control information (DCI) of the PDCCH. Moreover, a TCI state may not be used if an offset between a scheduling DCI and a PDSCH is not appropriate or does not satisfy threshold conditions. In one example, if a timing offset between a DCI and PDSCH is less than a certain time threshold, an associated TCI state may not be used. In other words, there may not be enough time for the UE to switch a beam of the UE according to the configured TCI state. As a result, a default QCL may be configured for scenarios where another QCL is unavailable. As used herein, another QCL is considered to be unavailable when a configured QCL cannot be used, is less preferred as compared to a default QCL, or another QCL is not configured.

For example, as described herein, a DCI may be received in the control region 302 of the scheduling cell 304. The DCI may indicate a TCI state to be used for data reception in the data region 312. However, if the time between the reception of the DCI by the UE and the scheduled reception of data in the data region 312 is less than a threshold, the UE may revert to using a default QCL. The default QCL may be a QCL associated with a TCI having the lowest ID among a set of activated TCIs. The activated TCI states may correspond to a subset of configured TCI states that are activated via medium access control (MAC) control element (CE) signaling, as described in more detail herein.

For a self-scheduling cell, a regular TCI state (e.g., as opposed to the TCI state for determining a default QCL) associated with QCL-TypeD for the scheduled PDSCH may be determined via RRC signaling. For example, RRC may be used to configure a set of TCI states for the PDSCH. The set of TCI-states configured via RRC may not be considered as active TCI states. Thus, a MAC CE may be used to select a subset of the RRC configured TCI states. The selected subset of TCI states may be considered as the set of activated TCI states. If the MAC CE selects a single TCI active state, no further DCI indication may be used. If a MAC CE selects more than a single active state, a DCI may be used to further select a TCI state from the subset of TCI states activated by the MAC CE. A DCI may not indicate or select a TCI state directly from the RRC configured set of TCI states.

Certain aspects of the present disclosure are directed to techniques for configuring a default QCL for cross-carrier scheduling. For example, to decode a PDSCH in a scheduled cell, a UE may assume a default QCL for the scheduled PDSCH when an otherwise configured QCL is unavailable. For instance, the UE may be configured with a set of TCI states, each of the TCI states being associated with identifier (ID). The UE may assume that the default QCL is the TCI state with the lowest ID applicable to the PDSCH among the set of TCI states. For example, the set of TCI states may include the TCI states via MAC-CE. In some cases, to decode a PDSCH in the scheduled cell, the UE may assume that the default QCL for the scheduled PDSCH is based on a TCI state explicitly configured for this purpose.

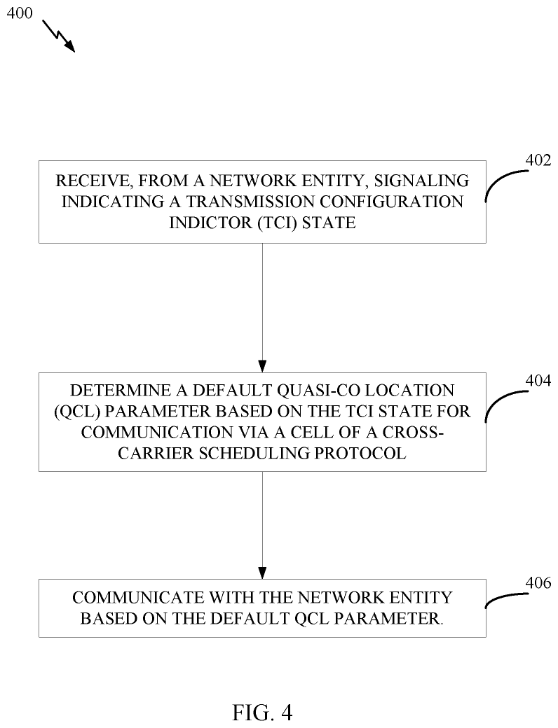

FIG. 4 is a flow diagram illustrating example operations 400 for wireless communication, in accordance with certain aspects of the present disclosure. The operations 400 may be performed by a UE, such as the UE 120. Operations 400 may be implemented as software components that are executed and run on one or more processors (e.g., controller/processor 280 of FIG. 2). Further, the reception of signals by the UE in operations 400 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 400 can begin, at block 402, by a UE receiving signaling from a network entity. The signaling may be control or data signaling. The signaling may be control signaling that indicates a TCI state or comprises TCI state information. The TCI state signaling may comprise at least one of RRC signaling, MAC CE, or DCI. TCI state signaling may also include additional or alternative types of control or information.

At block 404, the UE may determine a QCL parameter. This may be a default QCL parameter or some non-default QCL parameter. The UE may determine a QCL parameter based on a TCI state (e.g., TCI state indicated by the signaling received at block 402) in some aspects. The UE determination may also be based on additional data or information either present locally at the UE or contained in communications the UE receives. For example, the additional data or information may be received via the same cell used to receive the signaling at block 402, or a different cell. According to some aspects, the UE may receive signaling associated with QCL via a scheduled cell, such as the scheduled cell 304, of a cross-carrier scheduling protocol. A cross-carrier scheduling protocol may be associated with a scheduling cell used to schedule resources in a scheduled cell, such as the scheduled cell 306.

At block 406, the UE communicates (e.g., receives a PDSCH) with the network entity based on the default QCL parameter (e.g., QCL-TypeD). For example, the UE may receive data or control information using the default QCL parameter. The default QCL parameter may be one of any type of QCL parameter, such as QCL-Type A (e.g., for Doppler shift, Doppler spread, average delay, and delay spread), QCL-Type B (e.g., for Doppler shift and Doppler spread), QCL-Type C (e.g., for Doppler shift and average delay), or QCL-Type D (e.g., for spatial receive (Rx) parameter). The default QCL parameter may be used for the communication when another QCL parameter is unavailable for communication, as described herein.

In certain aspects, a UE receiving signaling may include receiving RRC signaling. The RRC signaling may comprise or indicate a set of TCI states. A set of TCI states can comprise data regarding one or more TCI states (distinct or not distinct). In some scenarios, a default QCL parameter may be determined based on a TCI of the set of TCI states having an ID of interest. For example, each of the set of TCI states may correspond to an ID. The UE may determine the default QCL based on one of the set of TCI states having a lowest ID among the set of TCI states. Also, in some scenarios, RRC signaling may be configured for an active bandwidth part (BWP) of a scheduled cell.

As mentioned above, in some scenarios, QCL parameter determination may be based on an ID associated with a TCI state. For example, a lowest TCI state ID used to determine the default QCL may be within a pool of TCI states. Such a pool of TCI states may be configured for a PDSCH in a scheduled cell. A TCI state pool may be the set of TCI states configured by RRC signaling for the scheduled PDSCH in the active BWP of the scheduled cell. However, setting the pool of TCI states via RRC configuration may be slow, which may be problematic in case the network entity seeks to change the default QCL. For example, the UE may be stuck using a relatively weak beam until the RRC configuration takes effect.

In certain aspects, the operations 400 may also include additional features. For example, operation 400 may include receiving RRC signaling configuring a set of TCI states. Signaling indicating the TCI state to be used for the determination of the default QCL parameter may be a MAC CE. The MAC CE may indicate one or more active TCI states of the set of the TCI states configured via the RRC signaling. The default QCL may be determined based on the TCI of the one or more active TCI states having the lowest ID, as described herein.

In other words, RRC may be used to configure a set of TCI states, followed by the MAC CE activating a subset of TCI states from the set of RRC configured TCI states. The subset of TCI states activated by MAC CE may be considered as the pool of TCI states. From this pool of TCI states, the UE may determine a TCI state based on which a default QCL parameter is to be determined. A BS may use this option to more quickly switch a default QCL parameter via a MAC CE. Network involvement may still be needed for QCL changes in some scenarios.

In certain aspects, a BS may explicitly configure a TCI state corresponding to a default QCL. For example, a new RRC parameter may be used to configure a TCI state for a default QCL (e.g., for a PDSCH in a scheduled cell). In other words, the signaling described in block 402 of operations 400 may include RRC signaling having an RRC parameter indicating the default QCL. However, in this case, reconfiguring to another default TCI state may be slow since reconfiguration using RRC signaling involves multiple steps and is relatively slow.

In certain aspects, a new MAC CE may be used to select a TCI state. The TCI state selection may occur from a pool of TCI states (e.g., configured to a PDSCH in a scheduled cell). In other words, the operations 400 may further include receiving RRC signaling configuring a set of TCI states. The signaling may indicate a TCI state corresponding to a default QCL parameter. The signaling may be done via a MAC CE indicating the TCI state of the set of the TCI states configured via RRC signaling. A default QCL may be determined based on a TCI indicated via the MAC CE. The determination of the default QCL may be based on IDs associated with TCI states activated via the MAC CE. Using a new MAC CE may be a faster option of setting a TCI state for the default QCL as compared to using RRC signaling.

Still yet, operations 400 may include additional features. For example, in certain aspects, the operations 400 may include receiving RRC signaling configuring a set of TCI states, and receiving a MAC CE indicating a subset of active TCI states of the set of TCI states configured via the RRC signaling. Signaling in block 402 may include DCI indicating a TCI state from the subset of active TCI states. In other words, a new DCI may be used to select a TCI state to be used for determining the default QCL. The DCI may be used to select a TCI state from the set of TCI states selected by MAC CE for determining the QCL for PDSCH reception in the scheduled cell. That is, the MAC CE may be used to indicate a subset of active TCI states from the set of TCI states indicated via RRC signaling. The DCI may be used to indicate and select a TCI state from this subset of TCI states to be used as the default QCL.

In certain aspects, signaling at block 402 may include RRC signaling configuring at least one control resource set (CORESET). The CORESET may be for a scheduled cell in some scenarios. A TCI state may be determined based on at least one search space set. In some aspects, the search space set may be associated with the CORESET. A CORESET and a search space set may be configured separately by different RRC signaling, in certain implementations. In the search space set configuration, there may be a CORESET ID field that indicates with which CORESET the search space set is associated.

In certain aspects, the at least one CORESET may not be used to indicate resources for decoding control information in the scheduled cell (e.g., since the control information is decoded in the scheduling cell for cross-carrier scheduling). The determination of the TCI state based on the search space set of the CORESET may involve determining the TCI state based on a time domain location where the at least one search space set is configured, as described in more detail herein.

In other words, a BS may configure at least one search space set in the at least one CORESET. A time domain location (e.g., periodicity, slot, symbols) where the at least one search space set is configured in the scheduled cell may be used to determine the default QCL. That is, the CORESET's configuration may indicate a TCI state that may be used to determine the default QCL for PDSCH. A search space set configuration may contain a pattern of symbols and slots (e.g., also referred to as a search space time domain periodicity pattern). The UE may determine the default QCL based on the pattern of symbols and slots.

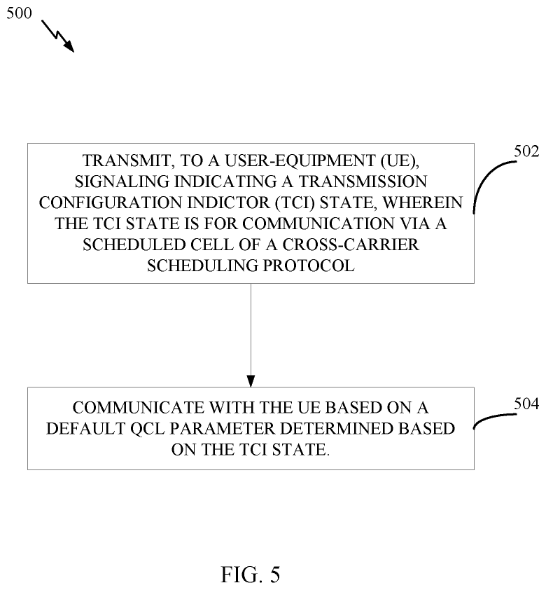

FIG. 5 is a flow diagram illustrating example operations 500 for wireless communication, in accordance with certain aspects of the present disclosure. The operations 500 may be performed, for example, by a network entity (e.g., such as a BS 110 in the wireless communication network 100). The operations 500 may be complimentary operations by the network entity to the operations 400 performed by the UE, as described herein. Operations 500 may be implemented as software components that are executed and run on one or more processors (e.g., controller/processor 240 of FIG. 2). Further, the transmission and reception of signals by the network entity in operations 500 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 500 may begin, at 502, by a network entity transmitting signaling to a UE. The signaling may be control or data signaling. The signaling may indicate a TCI state. The signaling may comprise at least one of RRC signaling, MAC CE, or DCI. TCI state signaling may also include additional or alternative types of control or information.

The TCI state may be for communication via a scheduled cell of a cross-carrier scheduling protocol. A cross-carrier scheduling protocol may be associated with a scheduling cell used to schedule resources in a scheduled cell, such as the scheduled cell 306.

At block 504, the network entity (e.g., BS) may communicate with the UE. The communication may be based on a default QCL parameter determined based on the TCI state. In certain aspects, the default QCL parameter may be used for the communication when another QCL parameter is unavailable, as described herein.

In some cases, transmitting the signaling may include transmitting the RRC signaling. The RRC signaling may indicate a set of TCI states. A set of TCI states may comprise data regarding one or more TCI states (distinct or not distinct). In some cases, a default QCL parameter may correspond to the TCI of the set of TCI states having an ID of interest. For example, each of the set of TCI states may correspond to an ID. The default QCL parameter may correspond to one of the set of TCI states having the lowest ID among the set of TCI states. In some scenarios, the RRC signaling may be configured for an active BWP of a scheduled cell.

In some cases, the operations 500 also include the network entity (e.g., BS) transmitting the RRC signaling configuring a set of TCI states. Signaling indicating the TCI state may include a MAC CE. The MAC-CE may indicate one or more active TCI states of the set of the TCI states configured via the RRC signaling. The default QCL may correspond to the TCI state of the one or more active TCI states having the lowest ID, as described herein.

In certain aspects, the signaling indicating the TCI state may include RRC signaling. The RRC signaling may include an RRC parameter indicating a default QCL. In certain aspects, the operations 500 also include the network entity (e.g., BS) transmitting RRC signaling configuring a set of TCI states. The signaling may include a MAC CE indicating the TCI state of the set of the TCI states configured via the RRC signaling. The default QCL may correspond to the TCI indicated via the MAC CE.

In certain aspects, the operations 500 may include the network entity (e.g., BS) transmitting RRC signaling configuring a set of TCI states. The operations 500 may also include transmitting MAC CE indicating a subset of active TCI states of the set of TCI states configured via the RRC signaling. The signaling indicating the TCI state used to determine the default QCL parameter may include DCI indicating the TCI state from the subset of active TCI states.

In certain aspects, the signaling indicating the TCI state may include RRC signaling. The RRC signaling may configure at least one CORESET. The TCI state used to determine the default QCL parameter may correspond to at least one search space set associated with the CORESET. In some scenarios, the at least one CORESET may be configured for the scheduled cell.

In certain aspects, the at least one CORESET may not be used to indicate resources for decoding control information in the scheduled cell since control information is decoded in the scheduling cell for cross-carrier scheduling. In certain aspects, the at least one search space set may include time domain locations corresponding to the default QCL parameter. In certain aspects, the TCI state used to determine the default QCL parameter may corresponds to a time domain location where the at least one search space set is configured.

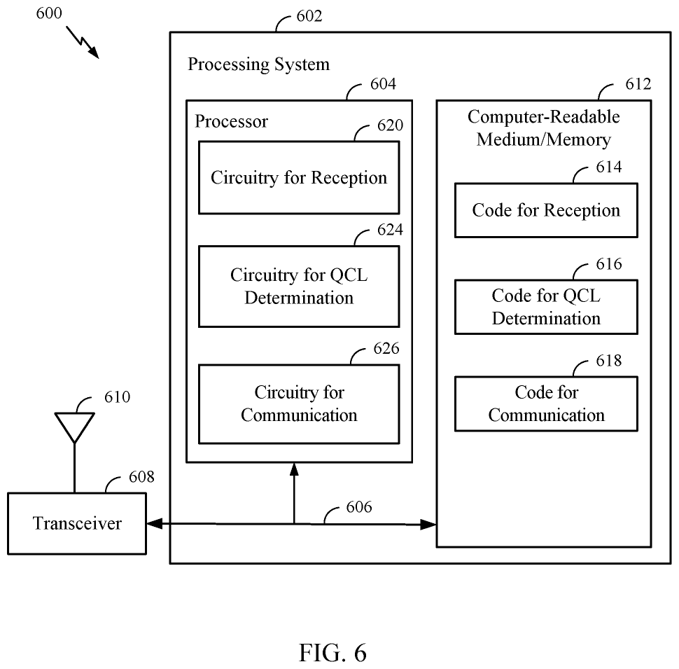

FIG. 6 illustrates a communications device 600 that may include various components (e.g., corresponding to means-plus-function components) configured to perform operations for the techniques disclosed herein, such as the operations illustrated in FIG. 4. The communications device 600 includes a processing system 602 coupled to a transceiver 608. The transceiver 608 is configured to transmit and receive signals for the communications device 600 via an antenna 610, such as the various signals as described herein. The processing system 602 may be configured to perform processing functions for the communications device 600, including processing signals received and/or to be transmitted by the communications device 600.

The processing system 602 includes a processor 604 coupled to a computer-readable medium/memory 612 via a bus 606. In certain aspects, the computer-readable medium/memory 612 is configured to store instructions (e.g., computer-executable code) that when executed by the processor 604, cause the processor 604 to perform the operations illustrated in FIG. 4, or other operations for performing the various techniques discussed herein for determining a default QCL and/or engage in cross-cell scheduling. In certain aspects, computer-readable medium/memory 612 stores code 614 for reception of signaling indicating a TCI state, code 616 for default QCL determination, and code 618 for communication using the default QCL. In certain aspects, the TCI determination module 121 may be implemented in software, and include the code 614 for reception, code 616 for default QCL determination, and code 618 for communication using the default QCL. In certain aspects, the processor 604 has circuitry configured to implement the code stored in the computer-readable medium/memory 612. The processor 604 may include circuitry 620 for reception of signaling indicating a TCI state, circuitry 624 for default QCL determination, and circuitry 626 for communication using the default QCL. In certain aspects, the TCI determination module 121 may be implemented in hardware, and may include the circuitry 620 for reception of signaling indicating a TCI state, circuitry 624 for default QCL determination, and circuitry 624 for communication using the default QCL.

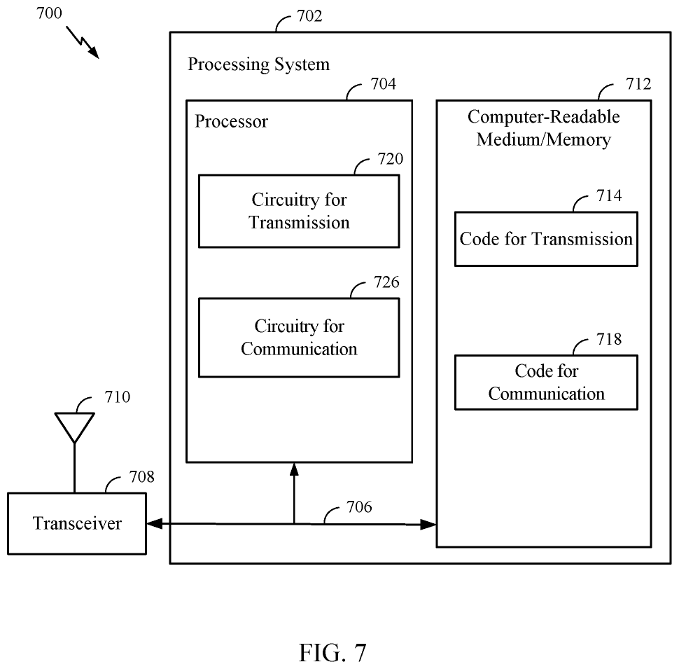

FIG. 7 illustrates a communications device 700 that may include various components (e.g., corresponding to means-plus-function components) configured to perform operations for the techniques disclosed herein, such as the operations illustrated in FIG. 4. The communications device 700 includes a processing system 702 coupled to a transceiver 708. The transceiver 708 is configured to transmit and receive signals for the communications device 700 via an antenna 710, such as the various signals as described herein. The processing system 702 may be configured to perform processing functions for the communications device 700, including processing signals received and/or to be transmitted by the communications device 700.

The processing system 702 includes a processor 704 coupled to a computer-readable medium/memory 712 via a bus 706. In certain aspects, the computer-readable medium/memory 712 is configured to store instructions (e.g., computer-executable code) that when executed by the processor 704, cause the processor 704 to perform the operations illustrated in FIG. 4, or other operations for performing the various techniques discussed herein for determining a default QCL. In certain aspects, computer-readable medium/memory 712 stores code 714 for transmission of signaling indicating TCI, and code 718 for communication using a default QCL that may be determined based on the TCI. In certain aspects, the TCI indication module 111 may be implemented in software, and may include the code 714 for transmission of signaling indicating the TCI, and the code 718 for communication using the default QCL. In certain aspects, the processor 704 has circuitry configured to implement the code stored in the computer-readable medium/memory 712. The processor 704 includes circuitry 720 for transmission of signaling indicating TCI, and circuitry 726 for communication using a default QCL that may be determined based on the TCI. In certain aspects, the TCI indication module 111 may be implemented in hardware, and may include the circuitry 720 for transmission of signaling indicating the TCI, and the circuitry 726 for communication using the default QCL.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communication, comprising:
receiving, from a network entity, signaling indicating a transmission configuration indictor (TCI) state;
determining a default quasi-co location (QCL) parameter based on the TCI state for communication via a first cell of a cross-carrier scheduling protocol; and
communicating with the network entity based on the default QCL parameter.

2. The method of claim 1, wherein the default QCL parameter is configured for communication when another QCL parameter is unavailable.

3. The method of claim 1, wherein receiving signaling comprises receiving radio resource control (RRC) signaling indicating a set of TCI states including the TCI state, wherein each of the set of TCI states is associated with an identifier (ID), and wherein the default QCL parameter is determined based on the TCI state of the set of TCI states having the lowest ID across the set of TCI states.

4. The method of claim 3, wherein the RRC signaling is configured for an active bandwidth part (BWP) of the first cell.

5. The method of claim 1, wherein:
the method further comprises receiving RRC signaling configuring a set of TCI states, each of the set of TCI states being associated with an ID;
the signaling indicating the TCI state comprises a medium access control (MAC) control element (CE) indicating one or more active TCI states of the set of the TCI states configured via the RRC signaling; and
the default QCL is determined based on the TCI state of the one or more active TCI states having the lowest ID across the set of TCI states.

6. The method of claim 1, wherein the signaling comprises RRC signaling having an RRC parameter indicating the default QCL.

7. The method of claim 1, wherein:
the method further comprises receiving RRC signaling configuring a set of TCI states;
the signaling comprises MAC CE indicating the TCI state of the set of the TCI states configured via the RRC signaling; and
the default QCL is determined based on the TCI state indicated via the MAC CE.

8. The method of claim 1, wherein:
the method further comprises receiving RRC signaling configuring a set of TCI states;
the method further comprises receiving MAC CE indicating a subset of active TCI states of the set of TCI states configured via the RRC signaling; and
the signaling comprises downlink control information (DCI) indicating the TCI state from the subset of active TCI states.

9. The method of claim 1, wherein the signaling comprises RRC signaling configuring at least one control resource set (CORESET), the TCI state being determined based on at least one search space set associated with the CORESET.

10. The method of claim 9, wherein the at least one CORESET is configured for the first cell.

11. The method of claim 9, wherein the at least one search space set comprises one or more time domain locations based on which the default QCL parameter is determined.

12. The method of claim 9, wherein determining the TCI state based on the at least one search space set comprises determining the TCI state based on a time domain location where the at least one search space set is configured.

13. The method of claim 1, wherein the cross-carrier scheduling protocol is associated with a second used to schedule resources in the first cell.

14. A method for wireless communication, comprising:
transmitting, to a user-equipment (UE), signaling indicating a transmission configuration indictor (TCI) state, wherein the TCI state is for communication via a first cell of a cross-carrier scheduling protocol; and
communicating with the UE based on a default QCL parameter determined based on the TCI state.

15. The method of claim 14, wherein the default QCL parameter is used for the communication when another QCL parameter is unavailable.

16. The method of claim 14, wherein transmitting the signaling comprises transmitting radio resource control (RRC) signaling indicating a set of TCI states, wherein each of the set of TCI states is associated with an identifier (ID), and wherein the default QCL parameter corresponds to the TCI of the set of TCI states having the lowest ID across the set of TCI states.

17. The method of claim 16, wherein the RRC signaling is configured for an active bandwidth part (BWP) of the first cell.

18. The method of claim 14, wherein:
the method further comprises transmitting RRC signaling configuring a set of TCI states, each of the set of TCI states being associated with an ID;
the signaling comprises medium access control (MAC) control element (CE) indicating one or more active TCI states of the set of the TCI states configured via the RRC signaling; and
the default QCL corresponds to the TCI state of the one or more active TCI states having the lowest ID across the set of TCI states.

19. The method of claim 14, wherein the signaling comprises RRC signaling having an RRC parameter indicating the default QCL.

20. The method of claim 14, wherein:
the method further comprises transmitting RRC signaling configuring a set of TCI states;
the signaling comprises MAC CE indicating the TCI state of the set of the TCI states configured via the RRC signaling; and
the default QCL corresponds to the TCI indicated via the MAC CE.

21. The method of claim 14, wherein:
the method further comprises transmitting RRC signaling configuring a set of TCI states;
the method further comprises transmitting MAC CE indicating a subset of active TCI states of the set of TCI states configured via the RRC signaling; and
the signaling comprises downlink control information (DCI) indicating the TCI state from the subset of active TCI states.

22. The method of claim 14, wherein the signaling comprises RRC signaling configuring at least one control resource set (CORESET), the TCI state corresponding to at least one search space set associated with the CORESET.

23. The method of claim 22, wherein the at least one CORESET is configured for the first cell.

24. The method of claim 22, wherein the at least one search space set comprises one or more time domain locations corresponding to the default QCL parameter.

25. The method of claim 22, wherein the TCI state corresponds to a time domain location where the at least one search space set is configured.

26. The method of claim 22, wherein the cross-carrier scheduling protocol is associated with a second cell used to schedule resources in the first cell.

27. An apparatus for wireless communication, comprising:
a memory; and
a processing system coupled to the memory, wherein the processing system and the memory are configured to:
receive, from a network entity, signaling indicating a transmission configuration indictor (TCI) state;
determine a default quasi-co location (QCL) parameter based on the TCI state for communication via a first cell of a cross-carrier scheduling protocol; and
communicate with the network entity based on the default QCL parameter.

28. An apparatus for wireless communication, comprising:
a memory; and
a processing system coupled to the memory, wherein the processing system and the memory are configured to:
transmit, to a user-equipment (UE), signaling indicating a transmission configuration indictor (TCI) state, wherein the TCI state is for communication via a first cell of a cross-carrier scheduling protocol; and
communicate with the UE based on a default QCL parameter determined based on the TCI state.
